(19) United States
(12) Patent Application Publication
(10) Pub. No.: US 2012/0133569 A1
(43) Pub. Date: May 31, 2012

(54) ANTENNA ARRAY

(76) Inventors: Florian Pivit, Dublin 15 (IE); Francis J. Mullany, Celbridge (IE)

(21) Appl. No.: 13/322,333

(22) PCT Filed: Apr. 19, 2010
(86) PCT No.: PCT/EP2010/002489

§ 371 Date: Feb. 7, 2012

(30) Foreign Application Priority Data
May 26, 2009 (EP) 09360027.8

(51) Int. Cl. H01Q 21/06

(52) U.S. Cl. 343/844

(57) ABSTRACT

An antenna array and a method are disclosed. The antenna array comprises: a plurality of active antenna elements, each active antenna element being separated by a predetermined first spacing distance; and a plurality of passive antenna elements, each passive antenna element being separated by a predetermined second spacing distance. By providing both active and passive antenna elements, multiple networks can be supported by the same antenna array. Providing a dual network antenna significantly simplifies base station provision since existing base station sites may be reused more readily. Also, the number of antenna arrays which need to be provided at those base stations sites may be significantly reduced, thereby reducing mast head congestion and also reducing mast head loadings since the mass of the dual antenna array and its wind loading characteristics will be significantly less than that of two separate antenna arrays.

### FIELD OF THE INVENTION

The present invention relates to an antenna array and a method.

### BACKGROUND

Antenna arrays are known. For example, in many mobile telecommunications systems, a number of base stations are arranged to communicate with a number of user equipment using antenna arrays located, typically on a mast head, at the base stations. Each base station is geographically separated from the others in order to provide communications coverage over a wide area. Each base station is typically arranged to support a number of “sectors” provided at extending outwards from the base station location. Each sector is typically supported by an antenna array and so an ‘n’ sector base stations will be supported by ‘n’ antenna arrays. Each antenna array is installed, orientated and configured to provide the required geographical coverage to user equipment.

Although such antenna arrays support wireless communications between user equipment and the base stations, their provision has a number of drawbacks.

Accordingly, it is desired to provide an improved antenna array.

### SUMMARY

According to a first aspect, there is provided an antenna array, comprising: a plurality of active antenna elements, each active antenna element being separated by a predetermined first spacing distance; and a plurality of passive antenna elements, each passive antenna element being separated by a predetermined second spacing distance.

The first aspect recognises that a problem with existing antenna arrays is that should a service provider wish to enhance the network or provide additional networks, then additional antenna arrays need to be installed. In particular, should a network provider currently providing a passive network wish to provide an active network, then an additional active antenna array needs to be provided. This is because currently passive antenna elements are provided on passive antenna arrays, whilst active antenna elements are provided on active antenna arrays. Also, it is not always possible to install additional antenna arrays on congested mast heads. Accordingly, an antenna array is provided comprising both active antenna elements and passive antenna elements. By providing both active and passive antenna elements, multiple networks can be supported by the same antenna array. Also, by enabling the active antenna elements to be separated by a first spacing distance and the passive antenna elements to be separated by a second spacing distance, the frequency characteristics of each of these different networks can readily be accommodated. In this way, it can be seen that, for example, an existing second generation (2G) base station implementation utilising a passive antenna can readily be upgraded to support third generation (3G) or fourth generation (4G) base station implementations requiring active antenna elements within the same antenna array. Likewise, the functionality of, for example, an existing 3G antenna array may be expanded to provide support for other, often legacy, networks. It will be appreciated that providing a dual network antenna significantly simplifies base station provision since existing base station sites may be reused more readily. Also, the number of antenna arrays which need to be provided at those base stations sites may be significantly reduced, thereby reducing mast head congestion and also reducing mast head loadings since the mass of the dual antenna array and its wind loading characteristics will be significantly less than that of two separate antenna arrays.

In one embodiment, the antenna array comprises an element spacing mechanism operable to change at least one of the first and second spacing distance. By providing an element spacing mechanism, the distance between the elements can be varied, adjusted or altered to suit the particular operating frequency characteristics of the networks being supported without needing to manufacture a bespoke antenna array for every possible conceivable combination of frequency characteristics that may be required. For example, the frequency characteristics of the networks supported by the passive antenna elements can vary from base station to base station. Each of those different frequency characteristics requires a different spacing between the passive antenna elements in the array; typically, the spacing between antennas may be set to 0.9 of the wavelength of the operating frequency. Likewise, the frequency characteristics of networks supported by the active antenna elements can change from base station to base station, which requires a similar change in the distance between each active antenna element in the array. Providing an element spacing mechanism enables the spacing between the antenna elements to readily be changed, dependent upon the particular implementation required for that base station.

In one embodiment, the element spacing mechanism is operable to change one of the first and second spacing distance. Accordingly, to simplify construction, the element spacing mechanism may be arranged so that only the first spacing distance or the second spacing distance may be changed.

In one embodiment, the element spacing mechanism comprises an elongate structure operable to retain one of the plurality of active antenna elements and the plurality of passive antenna elements to enable the one of the first and second spacing distance to be changed. It will be appreciated that an elongate structure provides a particularly convenient arrangement to enable the spacing of those antenna elements to be adjusted to the required spacing distance.

In one embodiment, one of the plurality of active antenna elements and the plurality of passive antenna elements comprise a modular antenna element and the antenna array comprises a retaining structure operable to receive and each modular antenna element at a corresponding one of the first and second spacing distance. Accordingly, the other antenna elements may be provided as individual modules retained within the antenna array, that retaining structure conveniently providing the required spacing between those antenna elements. In this way, it can be seen that both the first and second spacing distances may be conveniently set.

In one embodiment, a frequency supported by the plurality of passive antenna elements is equivalent to a frequency supported by the plurality of active antenna elements and the first and second distance is substantially equal. Hence, when the frequencies of the passive and active networks are generally equal, then the distance between the active antenna elements and between the passive antenna elements are also generally equal.

In one embodiment, a frequency supported by the plurality of passive antenna elements is lower than a frequency supported by the plurality of active antenna elements and the first distance is greater than the second distance. Accordingly, when the frequency of the passive network is lower than that of the active network, then the spacing between each passive antenna element will be greater than that between each active antenna element.

In one embodiment, a frequency supported by the plurality of passive antenna elements is higher than a frequency supported by the plurality of active antenna elements and the first distance is less than the second distance. Accordingly, when the frequency of the passive network is higher than that of the active network, then the spacing between the each passive antenna element will be smaller than that between each active antenna element.

In one embodiment, each active antenna element comprises two antennas, each of the two antennas being spaced apart and each passive antenna being located in a region between each of the two antennas. Accordingly, when the active antenna element is made of two antenna elements, the space between these two antenna elements may conveniently be utilised for the location of the passive antenna elements. It will be appreciated that this provides a particularly compact antenna array arrangement.

In one embodiment, each of the two antennas is orientated to provide orthogonal polarisation and each passive antenna is located in regions defined by the orientation. Hence, the orientation of the antenna elements, which may be of quadrilateral shaped, provides defined areas on the antenna array over which the passive antenna elements may be located. Once again, it will be appreciated that this provides for a particularly compact antenna array arrangement.

In one embodiment, the passive antennas upstand from the antenna array further than the active antennas. Providing passive antenna elements which extend beyond the active antenna elements reduces any spatial interference between these antenna elements on the antenna array. It will be appreciated that this provides for a particularly compact antenna array arrangement.

In one embodiment, the plurality of passive antenna elements are coupled with a passive feed network disposed along the antenna array.

According to a second aspect, there is provided a method, comprising the steps of: providing a plurality of active antenna elements; separating each active antenna element by a predetermined first spacing distance; providing a plurality of passive antenna elements; and spacing each passive antenna element by a predetermined second spacing distance.

Further particular and preferred aspects are set out in the accompanying independent and dependent claims. Features of the dependent claims may be combined with features of the independent claims as appropriate, and in combinations other than those explicitly set out in the claims.

### BRIEF DESCRIPTION OF THE DRAWINGS

Embodiments of the present invention will now be described further, with reference to the accompanying drawings, in which:

FIGS. 1A to 1C illustrate schematically three different configurations of antenna array according to embodiments;

FIG. 2 illustrates schematically an arrangement of modular active antenna elements according to one embodiment; and

FIG. 3 illustrates schematically an antenna array having a rail structure for receiving passive antenna elements according to one embodiment.

### DESCRIPTION OF THE EMBODIMENTS

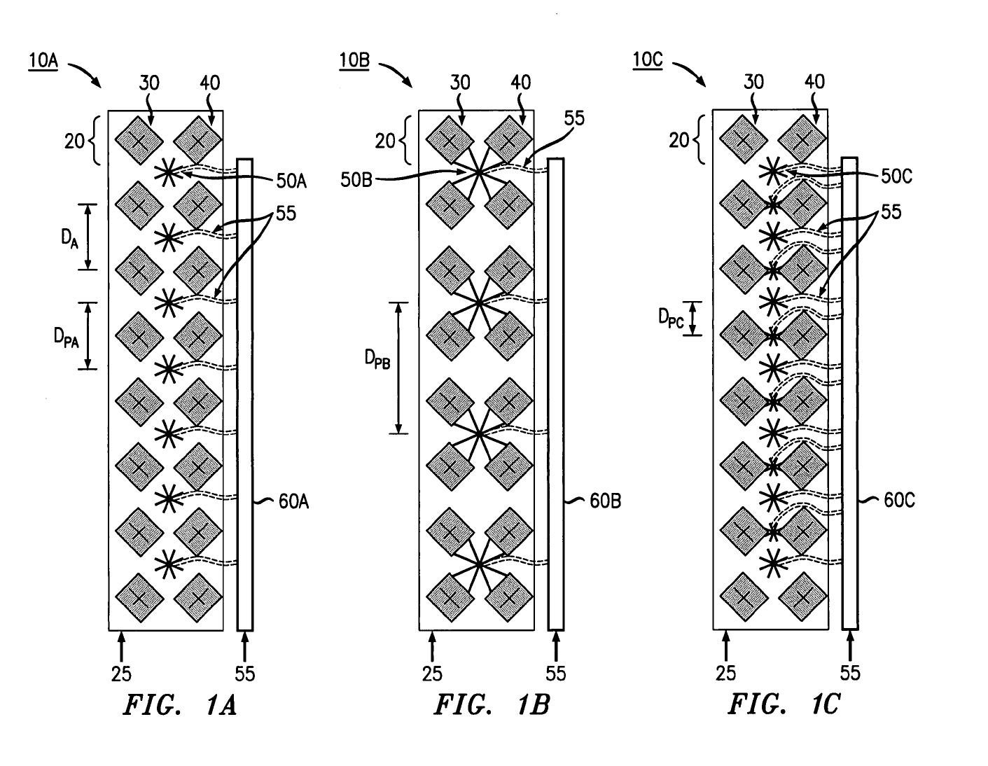

FIGS. 1A to 1C illustrate different arrangements of an antenna array according to embodiments which integrate an active array with a passive array. In a passive array, it is possible to provide coverage to user equipment within the sector supported by that passive array. It is possible to apply a phase and/or amplitude shift to the single transmission from the passive array to form the beam to shape the coverage provided to all user equipment within that sector. In an active array, it is also possible to provide coverage to user equipment within the sector supported by that active array. However, it is possible to apply a phase and/or amplitude shift to every transmission from the passive array to form the beam to shape the coverage provided separately to each user equipment within that sector; such an arrangement significantly improves the signal to noise ratio (SNR) and the signal to interference ratio of transmissions within network, which are particularly critical measures in some systems, such as, for example, WCDMA. Combining an active and passive array within a single antenna array provides for cost-effective base station configuration and deployment by enabling the co-deployment of newly emerging active antenna solutions for 3G and 4G implementations, particularly where there is already a 2G base station with a passive antenna arrangement. Co-locating the passive and active antenna elements integrates the passive array into the active array. This enables any existing passive 2G array to be replaced with a dual active/passive implementation and the rest of the 2G base station equipment from the cables to the remote radio heads (if any), as well as any supporting base station cabinets can remain in place to support the pre-existing network. When the 3G or 4G network is required, the additional cabling for the active antenna array is simply added, together with any supporting base station cabinets required for that network. This enables the existing base station site to be reused, even if the current mast head is completely congested and unable to support even one further antenna array since that pre-existing array may simply be removed and replaced with a dual active/passive implementation.

In the arrangements shown in FIGS. 1A to 1C, each active antenna element 20 comprises a twin-antenna 30, 40 arrangement where one antenna provides for a +45° polarised transmitter and a −45° polarised receiver, whereas the second antenna provides a −45° polarised transmitter and a +45° polarised receiver. Each active antenna element 20 is driven by a separate digital signal provided over a data and power coupling 25 from the supporting base station cabinet (not shown) located at ground level. Each digital signal is decoded by the active antenna element 20, amplified, filtered and transmitted. Several of these active antenna elements 20 are provided to build the complete antenna array 10A to 10C. In the examples shown, eight active antenna elements 20 are provided in each antenna array 10A to 10C. However, it will be appreciated, that more or less active antenna elements 20 may be provided in order to produce an antenna array of the appropriate size to provide the required power output and gain.

Also located on each antenna array 10A to 10C is a number of passive antennas 50A to 50C. These passive antennas 50A to 50C are located generally in a region defined between each active antenna 30, 40. In addition, each passive antenna 50A to 50C is spatially separated from the active antennas 30, 40 since the passive antennas extend away from the surface of the antenna array a greater distance than the active antenna elements 30, 40 (i.e. they upstand from the antenna array in a direction out of the paper). Each passive antenna 50A to 50C couples via a radio frequency (RF) feed 55, which is in turn coupled to a passive RF feed network 60A to 60C to provide the appropriate amplitude and/or phase shift to the incoming signal. The passive RF feed network 60A to 60C receives the RF signal from supporting base station cabinets (not shown) located at ground level.

In the arrangements shown in FIGS. 1A to 1C, the distance DA between the active antenna elements 20 is the same for each example. However, it will be appreciated that the distance DA may differ from implementation to implementation, dependent upon the transmission frequency of the active antenna elements 20. Generally, the distance DA is set to be approximately 0.9 of the wavelength of the operating frequency.

As shown in FIG. 1A, the passive antennas 50A are operating generally in the same frequency band as the active antenna elements 20 (for example the active antenna elements 20 may be operating in UMTS2100 and the passive antennas 50A may be operating in GSM1800), the spacing between adjacent active antennas 30, 40 is occupied by a passive antenna 50a and the distance D_{PA} between the passive antennas 50A is generally equal to the distance D_{A}.

In FIG. 1B, the passive antennas 50B operate at a lower frequency than the active antennas 30, 40 (for example, the active antennas 30, 40 may be operating in UMTS2100 and the passive antennas 50B may be operating in GSM900). In this arrangement every second (or less) spacing between active antennas 30, 40 is occupied by a passive antenna 50B. Accordingly, the distance D_{PB} between the passive antennas 50B is greater than the distance D_{A}.

In FIG. 1C, the passive antennas 50C operate at a higher frequency than the active antennas 30, 40 (for example, the active antennas 30, 40 may operate at LTE900 and the passive antennas 50C at GSM 1800 or UMTS2100). In this arrangement, more than one passive antenna 50C is placed between the active antennas 30, 40. Hence, the distance D_{PC} between the passive antennas 50C is smaller than the distance DA.

The feed network 60A to 60C for the passive antennas 50A to 50C is placed either behind the active antenna elements 20 or to the side of the antenna array. The signal from the feed network 60A to 60C is fed into the antenna elements 50A to 50C using coaxial cables 55.

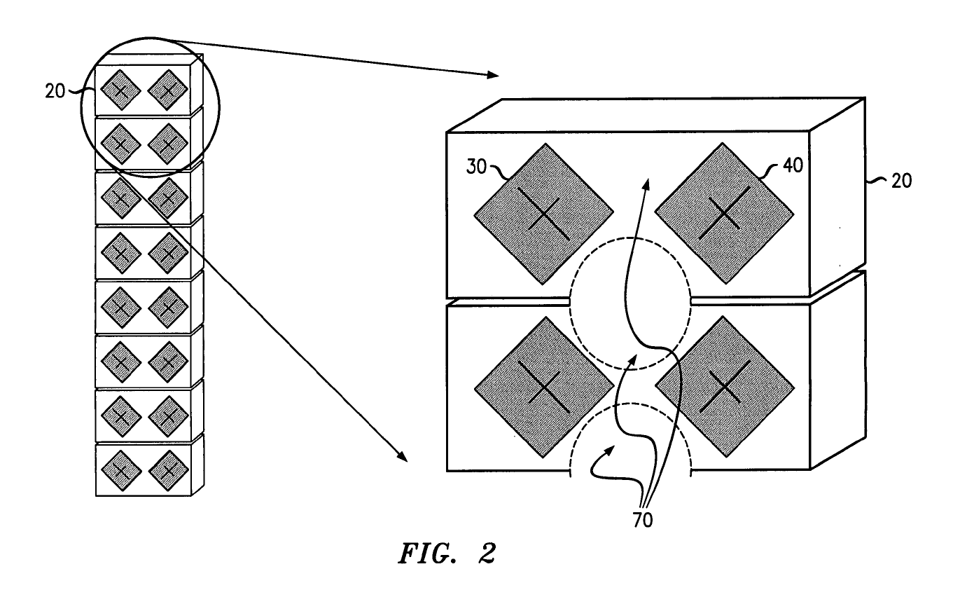

FIG. 2 illustrates in more detail an example arrangement of the active antenna elements 20. As can be seen, these active antenna elements 20 are provided as modules, which may be placed together to form an antenna array of the appropriate characteristics. The provision of modular active antenna element 20 reduces the diplexer specification of the antenna array due to the band-separating characteristic of the design path, whilst at the same time providing the opportunity to place other antennas in spaces 70 between the active antennas 30, 40. It will be appreciated that other configurations of active antennas 30, 40 are possible and the principles described here also apply. By using the space 70 between the active antennas 30, 40 and placing passive radiators in this space, the passive array is integrated into the active structure to provide a compact dual antenna array.

The active and passive structures can operate in the same frequency band or in different bands. In the examples given, two active antennas 30, 40 per active antenna element are provided so that integration is particularly simple, but other configurations are possible.

By using these modular active antenna elements 20, it is possible to also vary the distance between each element 20 by simply spacing these elements 20 apart by a predetermined distance. It will be appreciated that this provides for a convenient technique for changing the frequency bands supported by the active antenna elements 20.

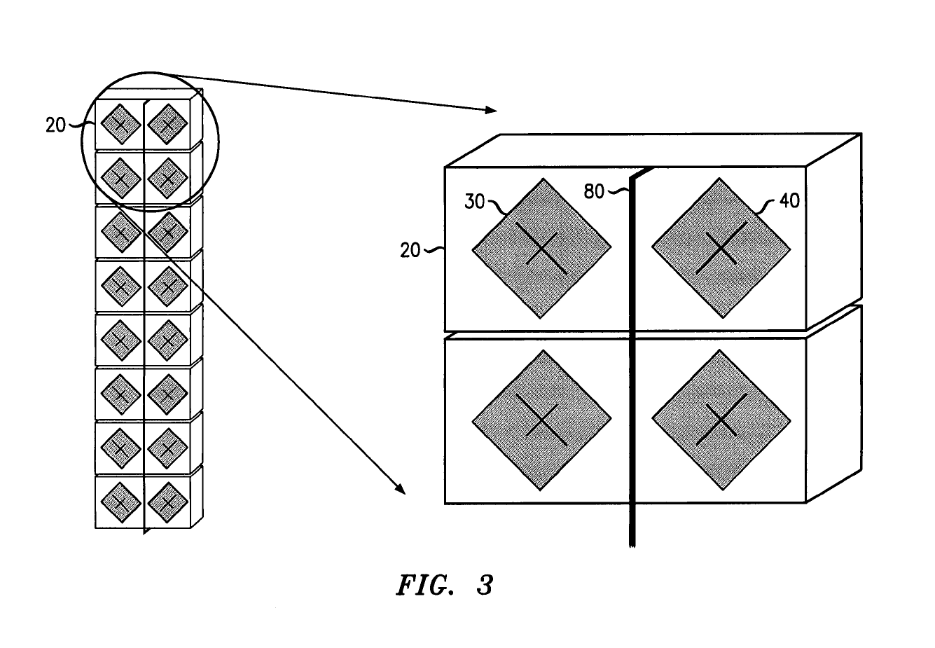

FIG. 3 illustrates an example arrangement for enabling the passive antennas 50A to 50C to be spaced any particular predetermined distance apart. Although it will be appreciated that it is possible to fix each passive antenna 50A to 50C to the surface of the active antenna elements 20, it will be appreciated that this may not be particularly convenient and may limit future reconfiguration of the antenna array. Accordingly, a rail 80 is provided which extends along the length of the antenna array, between each active antenna 30, 40. The passive antennas 50A to 50C are then located on this rail 80 and positioned along the rail 80 at the required separation distance for the intended passive network operating frequency. This enables the frequency of the passive network to easily be set or changed, depending on the required implementation. Once the passive elements 50A to 50C are in place, these are once again fed via the passive RF fed network 60A to 60C and the coupling coaxial cables 55.

Accordingly, it can be seen that embodiments allow the provision of active antenna arrays not as a single solution, but also as a legacy product since the existing infrastructure (for example a 2G GSM base station) can continue be used at the same site, whilst still providing enhanced services. By replacing an existing passive 2G antenna array with a new active/passive integrated antenna which contains an active 3G or 4G antenna array as well as the passive 2G antenna array, the system can be upgraded without installing additional, separate antenna arrays and at the same time the operator can keep any current equipment operational. Furthermore, any incidence of antenna congestion can be dramatically reduced during network upgrading.

It should be appreciated by those skilled in the art that any block diagrams herein represent conceptual views of illustrative circuitry embodying the principles of the invention.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. An antenna array, comprising:
a plurality of active antenna elements, each active antenna element being separated by a predetermined first spacing distance; and
a plurality of passive antenna elements, each passive antenna element being separated by a predetermined second spacing distance.

2. The antenna array of claim 1, comprising an element spacing mechanism operable to change at least one of the first and second spacing distance.

3. The antenna array of claim 2, wherein said element spacing mechanism is operable to change one of the first and second spacing distance.

4. The antenna array of claim 3, wherein said element spacing mechanism comprises an elongate structure operable to retain one of said plurality of active antenna elements and said plurality of passive antenna elements to enable said one of the first and second spacing distance to be changed.

5. The antenna array of claim 1, wherein one of said plurality of active antenna elements and said plurality of passive antenna elements comprise a modular antenna element and said antenna array comprises a retaining structure operable to receive and each modular antenna element at a corresponding one of said first and second spacing distance.

6. The antenna array of claim 1, wherein a frequency supported by said plurality of passive antenna elements is equivalent to a frequency supported by said plurality of active antenna elements and said first and second distance is substantially equal.

7. The antenna array of claim 1, wherein a frequency supported by said plurality of passive antenna elements is lower than a frequency supported by said plurality of active antenna elements and said first distance is greater than said second distance.

8. The antenna array of claim 1, wherein a frequency supported by said plurality of passive antenna elements is higher than a frequency supported by said plurality of active antenna elements and said first distance is less than said second distance.

9. The antenna array of claim 1, wherein each active antenna element comprises two antennas, each of said two antennas being spaced apart and each passive antenna being located in a region between each of said two antennas.

10. The antenna array of claim 9, wherein each of said two antennas are orientated to provide orthogonal polarisation and each passive antenna is located in regions defined by said orientation.

11. The antenna array of claim 1, wherein said passive antennas upstand from said antenna array further than said active antennas.

12. The antenna array of claim 1, wherein said plurality of passive antenna elements are coupled with a passive feed network disposed along said antenna array.

13. A method, comprising the steps of:
providing a plurality of active antenna elements;
separating each active antenna element by a predetermined first spacing distance;
providing a plurality of passive antenna elements; and
spacing each passive antenna element by a predetermined second spacing distance.
